(19) United States
(12) Patent Application Publication
(10) Pub. No.: US 2009/0289511 A1
(43) Pub. Date: Nov. 26, 2009

(54) VIBRATION ABSORBING BEARING AND BLOWER MOTOR FOR VEHICLES HAVING THE SAME

(75) Inventor: Moo Yong KIM, Suwon-si (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/336,292

(22) Filed: Dec. 16, 2008

(30) Foreign Application Priority Data
May 26, 2008 (KR) 10-2008-0048723

(51) Int. Cl. H02K 5/24; F16C 32/06

(52) U.S. Cl. 310/51; 384/115

(57) ABSTRACT

A vibration absorbing bearing supports an armature shaft and a blower motor for vehicles. The vibration absorbing bearing may include a longitudinal groove which is formed on the inner circumference of the bearing in such a way as to extend in a longitudinal direction and hold a lubricant therein. The blower motor for vehicles may include a main body, a stator installed in the main body, an armature assembly installed in the main body and having an armature shaft, and the vibration absorbing bearing. Such a construction improves the durability of components and achieves the joining of the components and the absorption of vibration, thus efficiently isolating cogging noise.

### CROSS-REFERENCE TO RELATED APPLICATIONS

The present application claims priority to Korean Application No. 10-2008-0048723 filed May 26, 2008, the entire contents of which application is incorporated herein for all purposes by this reference.

### BACKGROUND OF THE INVENTION

1. Field of the Invention

The present invention relates to a vibration absorbing bearing and a blower motor for vehicles having the vibration absorbing bearing.

2. Description of Related Art

Generally, an air conditioning system for vehicles includes a suction device which draws and transmits external air, a compressor which compresses a refrigerant, a condenser which cools the refrigerant, an expansion valve which reduces the pressure of the liquid refrigerant, and a heat exchanger which performs a heat exchanging process between the refrigerant and the external air through the change in phase of the refrigerant.

Among them, the suction device drives a blower motor to rotate a blower fan, so that the external air is forcibly delivered into the heat exchanger.

As shown in FIG. 7, the conventional suction device includes the blower fan 10 and the blower motor 20 operatively connected thereto, thus operating the blower fan 10.

Further, the blower motor 20 includes a motor casing 21, a stator 22, a brush assembly 23, and an armature assembly 25. The motor casing 21 defines the external appearance of the blower motor 20. The stator 22 is attached to the inner circumference of the motor casing 21. The brush assembly 23 is provided at a predetermined position in the motor casing 21. The armature assembly 25 is installed in the motor casing 21. The armature assembly 25 is provided with an armature coil 26 which is arranged to correspond to the stator 22, and an armature shaft 27 which is supported by a bearing 28.

However, the conventional blower motor is problematic in that vibration and noise are generated due to the operation of the blower motor. Particularly, when oil between the armature shaft and the bearing for supporting the armature shaft runs out, the armature shaft and the bearing are put in direct contact with each other, so that the blower motor does not operate smoothly, and noise and abrasion may occur because of friction between the armature shaft and the bearing.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a vibration absorbing bearing and a blower motor for vehicles having the vibration absorbing bearing, which can reduce the vibration of the blower motor and isolate cogging noise.

In an aspect of the present invention, a vibration absorbing bearing having a hollow portion for supporting an armature shaft therein may include at least a longitudinal groove formed in an inner circumference of the hollow portion to extend in a longitudinal direction thereof in a predetermined angle with a longitudinal axis and holding a lubricant therein.

The longitudinal groove may have a determined radius and concavely engraved in the inner circumference of the vibration absorbing bearing.

The hollow portion may have a polygonal shape at cross section to support an outer surface of the armature shaft. The hollow portion may have a hexagonal shape at cross section.

The vibration absorbing bearing may be a sintered bearing.

The vibration absorbing bearing may further include at least a transverse groove formed in the inner circumference of the hollow portion to extend in a transverse direction in a predetermined angle with a traverse axis of the vibration absorbing bearing and holding the lubricant therein. Transverse grooves may be arranged to be spaced apart from each other in the longitudinal direction.

Projections may protrude from upper and lower portions of the vibration absorbing bearing toward the armature shaft, to support the armature shaft, and a storage groove is formed at inner surface of the vibration absorbing bearing in a middle portion thereof to be surrounded by the projections, and holds the lubricant therein.

In another aspect of the present invention, a blower motor for a vehicle may include a main body, a stator installed in the main body, an armature assembly rotatably enclosed by the stator in the main body and including an armature shaft, and/or a hollow vibration absorbing bearing having a hollow portion to support the armature shaft and having at least a longitudinal groove formed in an inner circumference of the hollow portion to extend in a longitudinal direction thereof with a predetermined angle with a longitudinal axis and holding a lubricant therein.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view illustrating an exemplary blower motor for vehicles and an exemplary vibration absorbing bearing according to the present invention.

FIG. 2 is an enlarged partial view illustrating portion “A” of FIG. 1.

FIG. 3 is a cross sectional view taken along line “B-B” of FIG. 2.

FIG. 4 is a cross sectional view illustrating another exemplary vibration absorbing bearing according to the present invention.

FIG. 5 is vertical sectional view illustrating another exemplary vibration absorbing bearing according to the present invention.

FIG. 6 is vertical sectional view illustrating another exemplary vibration absorbing bearing according to the present invention.

FIG. 7 is a view illustrating the construction of a conventional blower motor for vehicles.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

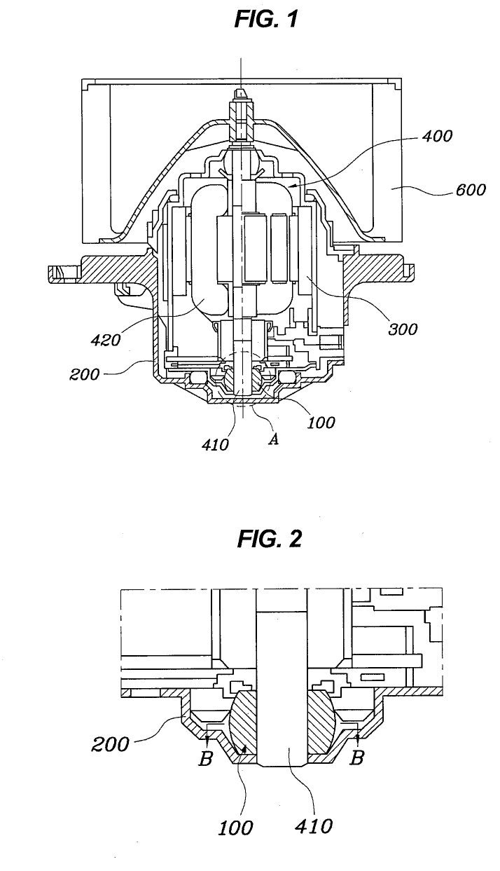

As shown in FIGS. 1 to 3, a blower motor according to various exemplary embodiments of the present invention is characterized in that a groove for holding a lubricant is formed in a bearing, thus achieving the joining of components and the absorption of vibration, therefore isolating cogging noise.

In order to accomplish the desired characteristics, various exemplary embodiments of the present invention are constructed such that the blower motor includes a main body 200 and a hollow vibration absorbing bearing 100 which is installed in the main body 200 to support the armature shaft 410 and has a longitudinal groove 110.

The main body 200 is a housing which defines the appearance of the motor. A blower fan 600 is mounted to the upper portion of the main body 200 to allow external air to flow into the main body 200, and a stator 300 and an armature assembly 400 are installed at predetermined positions in the main body 200. An armature assembly 400 is provided with an armature coil 420 which is arranged to face the stator 300, and an armature shaft 410 which is supported by the vibration absorbing bearing 100.

Here, since the blower fan 600, the stator 300, the armature coil 420, and the armature shaft 410 correspond to a blower fan, a stator, an armature coil, and an armature shaft of a conventional air conditioning system, they will not be described in detail herein.

The vibration absorbing bearing 100 is a hollow bearing which supports the armature shaft 410, and comprises a sintered bearing which is manufactured by forming and sintering powder particles.

Further, the vibration absorbing bearing 100 includes the longitudinal groove 110 which extends in a longitudinal direction in a predetermined angle with a longitudinal axis of the vibration absorbing bearing 100 on the inner circumference of the vibration absorbing bearing 100. Since the longitudinal groove 110 retains the lubricant therein so that it is always held in the bearing, the durability of components is improved, and the joining of the components and the absorption of vibration are achieved, thereby isolating cogging noise.

In various embodiments of the present invention, the predetermined angle is approximately zero degree. However one may appreciate that the angle can be determined based on the rotation speed of armature shaft, viscosity of lubricant or other factors.

The longitudinal groove 110 may be realized by the hollow portion in the vibration absorbing bearing 100. That is, the hollow portion includes a polygonal shape, whose lateral sides support the outer surface of the armature shaft 410, and each corner of the inner circumference of the hollow part serves as the longitudinal groove 110 to retain lubricants therein. In various embodiments of the present invention, the hollow portion includes a hexagonal shape. As such, since the lubricant is contained in each corner of the inner circumference of the hexagonal hollow portion, the smooth operation of the armature shaft 410 is possible.

As shown in FIG. 4, the longitudinal groove 110 may be formed to be concave in the inner surface of the vibration absorbing bearing 100. The longitudinal groove 110 is a strip-shaped groove which extends in the longitudinal direction on the inner circumference of the vibration absorbing bearing 100, and comprises a plurality of grooves which are formed in the inner circumference of the vibration absorbing bearing 100 at predetermined intervals. Since the longitudinal grooves 110 having such a shape contain the lubricant, the durability of components is improved, and the joining of the components and the absorption of vibration are achieved, thereby isolating cogging noise.

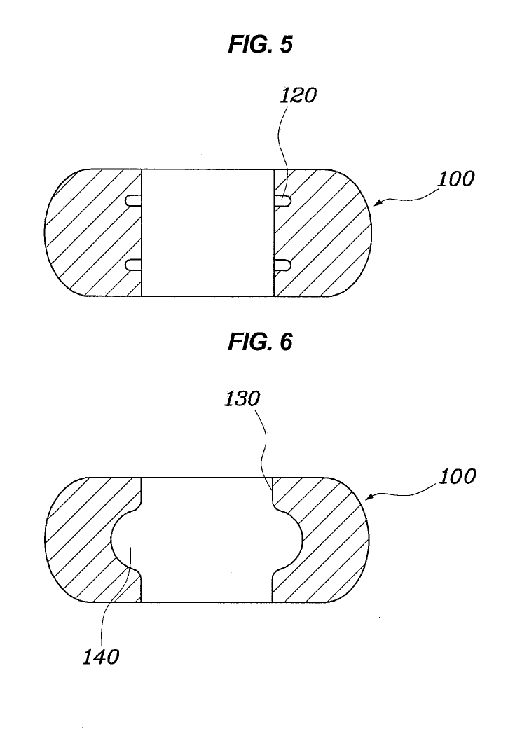

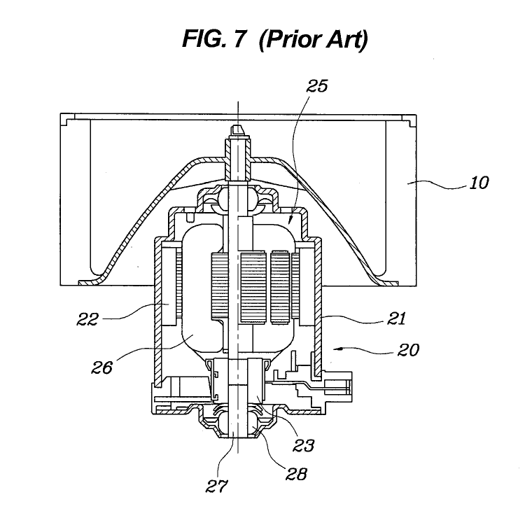

As shown in FIG. 5, the vibration absorbing bearing 100 may further include a transverse groove 120 which is formed in the inner circumference of the vibration absorbing bearing 100 in such a way as to extend in a transverse direction in a predetermined angle with a traverse axis of the vibration absorbing bearing 100. Such a transverse groove 120 may comprise a plurality of transverse grooves which are formed in the inner circumference of the vibration absorbing bearing 100 in such a way as to be spaced apart from each other in a longitudinal direction.

In various embodiments of the present invention, the predetermined angle is approximately zero degree. However one may appreciate that the angle can be determined based on the rotation speed of armature shaft viscosity of lubricant or other factors.

Since the transverse grooves 120 contain the lubricant therein, the lubricant can be always retained in the bearing 100, so that the durability of components is improved, and the joining of the components and the absorption of vibration are achieved, thereby isolating cogging noise.

As shown in FIG. 6, projections 130 may protrude from the upper and lower portions of the vibration absorbing bearing 100, and a storage groove 140 may be formed on the middle portion of the vibration absorbing bearing 100 in such a way as to be surrounded by the projections 130. The projections 130 are in contact with and support the armature shaft 410, and the storage groove 140 contains the lubricant therein, so that the durability of components is improved, and the joining of the components and the absorption of vibration are achieved, thereby isolating cogging noise.

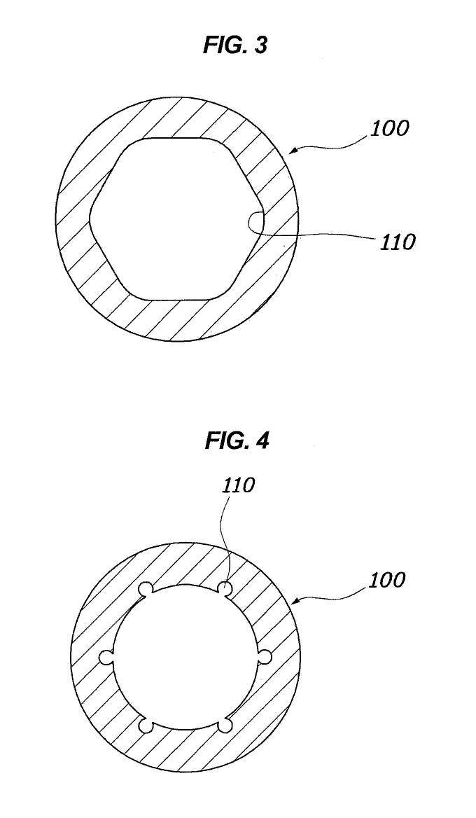

Meanwhile, one will appreciate that the exemplary embodiment shown in FIG. 3, the exemplary embodiment shown in FIG. 4, the exemplary embodiment shown in FIG.5 and the fourth exemplary embodiment shown in FIG. 4 may be combined to more effectively retain lubricant in the vibration absorbing bearing 100.

According to various aspects of the present invention, the vibration absorbing bearing 100 is provided with the longitudinal grooves 110 to retain the lubricant therein, so that the durability of components is improved, and the joining of the components and the absorption of vibration are achieved, thereby isolating the cogging noise. Since the construction of the vibration absorbing bearing 100 remains the same as that of the vibration absorbing bearing 100 applied to the blower motor, its detailed description will be omitted herein.

The vibration absorbing bearing 100 may be applied to various kinds of motors as well as the blower motor for vehicles.

As described above, the present invention is advantageous in that a lubricant is retained in a bearing, thus preventing the consumption of the lubricant and increasing the durability of components.

Further, the present invention is advantageous in that the vibration of a blower motor is reduced, thus isolating cogging noise resulting from vibration of the blower motor.

For convenience in explanation and accurate definition in the appended claims, the terms “upper” and “lower” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vibration absorbing bearing having a hollow portion for supporting an armature shaft therein, the vibration absorbing bearing comprising:
a longitudinal groove formed in an inner circumference of the hollow portion to extend in a longitudinal direction thereof in a predetermined angle with a longitudinal axis and holding a lubricant therein.

2. The vibration absorbing bearing as set forth in claim 1, wherein the longitudinal groove has a predetermined radius and is concavely engraved in the inner circumference of the vibration absorbing bearing.

3. The vibration absorbing bearing as set forth in claim 1, wherein the hollow portion has a polygonal shape at cross section to support an outer surface of the armature shaft.

4. The vibration absorbing bearing as set forth in claim 3, wherein the hollow portion has a hexagonal cross section.

5. The vibration absorbing bearing as set forth in claim 1, wherein the vibration absorbing bearing is a sintered bearing.

6. The vibration absorbing bearing as set forth in claim 1, further comprising:
a transverse groove formed in the inner circumference of the hollow portion extending in a transverse direction in a predetermined angle with a traverse axis of the vibration absorbing bearing and holding the lubricant therein.

7. The vibration absorbing bearing as set forth in claim 6, wherein the transverse grooves are arranged to be spaced apart from each other in the longitudinal direction.

8. The vibration absorbing bearing as set forth in claim 1, wherein projections protrude from upper and lower portions of the vibration absorbing bearing toward the armature shaft to support the armature shaft, and a storage groove is formed at inner surface of the vibration absorbing bearing in a middle portion thereof surrounded by the projections, and holds the lubricant therein.

9. A blower motor for a vehicle, comprising:
a main body;
a stator installed in the main body;
an armature assembly rotatably enclosed by the stator in the main body and including an armature shaft; and
a hollow vibration absorbing bearing having a hollow portion to support the armature shaft and having a longitudinal groove formed in an inner circumference of the hollow portion to extend in a longitudinal direction thereof with a predetermined angle with a longitudinal axis and holding a lubricant therein.

10. The blower motor for a vehicle as set forth in claim 9, wherein the longitudinal groove has a determined radius and is concavely engraved in the inner circumference of the vibration absorbing bearing.

11. The blower motor for a vehicle as set forth in claim 9, wherein the hollow portion has a polygonal shape cross section to support an outer surface of the armature shaft.

12. The blower motor for a vehicle as set forth in claim 11, wherein the hollow portion has a hexagonal cross section.

13. The blower motor for a vehicle as set forth in claim 9, wherein the vibration absorbing bearing is a sintered bearing.

14. The blower motor for a vehicle as set forth in claim 9, further comprising:
a transverse groove formed in the inner circumference of the hollow portion to extend in a transverse direction in a predetermined angle with a traverse axis of the vibration absorbing bearing and holding the lubricant therein.

15. The blower motor for a vehicle as set forth in claim 14, wherein the transverse grooves are arranged to be spaced apart from each other in the longitudinal direction.

16. The blower motor for a vehicle as set forth in claim 9, wherein projections protrude from upper and lower portions of the vibration absorbing bearing toward the armature shaft, to support the armature shaft and a storage groove is formed at inner surface of the vibration absorbing bearing in a middle portion thereof in such a way as to be surrounded by the projections, and holds the lubricant therein.

17. A passenger vehicle comprising the blower motor as set forth in claim 9.

18. A blower motor comprising the vibration absorbing bearing as set forth in claim 1.

19. A passenger vehicle comprising the blower motor as set forth in claim 18.
